(19) United States
(12) Patent Application Publication
(10) Pub. No.: US 2015/0378458 A1
(43) Pub. Date: Dec. 31, 2015

(54) TOUCH SENSING MODULE

(71) Applicant: CANDO CORPORATION, Hsinchu County (TW)

(72) Inventors: CHI-KUANG LAI, Taoyuan (TW); FENG-YU CHIANG, Taoyuan (TW); JYH-YU LIU, Hsinchu (TW); TE-LUNG CHENG, Miaoli (TW)

(21) Appl. No.: 14/557,532

(22) Filed: Dec. 2, 2014

(30) Foreign Application Priority Data
Jun. 26, 2014 (TW) 103122172

(51) Int. Cl. G06F 3/041

(52) U.S. Cl. CPC G06F 3/041; G06F 2203/04103

(57) ABSTRACT

A touch sensing module includes a touch sensing circuit substrate, a glass substrate, a shielding layer, and an adhering member. The shielding layer is made of a photoresist material, and is provided on the glass substrate to shield a periphery thereof. The adhering member has a first adhering layer and a second adhering layer which are adhered to each other, wherein the first adhering layer is adhered on the glass substrate and the shielding layer, while the second adhering layer is adhered on the touch sensing circuit substrate. An area of the first adhering layer facing the glass substrate is smaller than that of the second adhering layer facing the touch sensing circuit substrate. Or, a hardness of the first adhering layer is less than that of the second adhering layer.

The current application claims a foreign priority to the patent application of Taiwan No. 103122172 filed on Jun. 26, 2014.

### BACKGROUND OF THE INVENTION

1. Technical Field

The present invention relates generally to an input device, and more particularly to a touch sensing module.

2. Description of Related Art

Touch screens are widely used for inputting data in a variety of electronic devices, and the manufacturing process of a touch screen usually includes the step of forming a touch sensing layer on a substrate made of glass or flexible material, and then the substrate is adhered to a display panel module to complete a touch screen.

An alternative and better manufacturing method of touch panels is to form a touch sensing circuit layer on a thin plastic substrate (thinner than 10 μm) first, and then the touch sensing circuit layer is adhered to a cover lens which has a shielding layer provided thereon with glutinous materials. A conventional touch sensing circuit layer not only includes a touch detection circuit, but also includes conductive traces and at least one bonding pad, wherein the conductive traces are used for delivering touch detection signals, while the bonding pad is used for connecting the conductive traces to a flexible circuit board. The shielding layer on the cover lens is usually made of black ink or photoresist materials, and is applied at where corresponding to the conductive traces and the bonding pad. In this way, the trace structure can be shielded from being visible.

However, in order to achieve better shielding effect, there are usually more than one shielding layer provided on one cover lens, and the shielding layers must have certain thickness altogether. Especially for colorful shielding layers, there have to be several layers to perform sufficient shielding effect, which leaves a gap between the shielding layers and the cover lens. In such cases, said glutinous materials may have air bubbles therein, and the yield of manufacturing would be decreased.

A conventional way to prevent from air bubbles is to coat thicker glutinous materials. Though this method effectively solves the problem, a thin plastic substrate may be deformed while a flexible circuit board being bounded to a bonding pad due to weak hardness resulted from the thickness of the glutinous materials. The circuit formed on the thin plastic substrate may be damaged and resulted in decreasing the yield of manufacturing.

Therefore, there is still room for improvement in manufacturing a touch panel module.

### BRIEF SUMMARY OF THE INVENTION

In view of the above, the primary objective of the present invention is to provide a touch sensing module, which effectively prevents air bubbles from being generated and also prevents touch sensing circuits from being damaged while bonding the flexible circuit board on the bonding pad.

The present invention provides a touch sensing module which includes a glass substrate, a shielding layer, an adhering member, and a touch sensing circuit substrate. The shielding layer is provided on a surface of the glass substrate, wherein the shielding layer partially shields the glass substrate, and the glass substrate has a visible portion not shielded by the shielding layer. The adhering member includes a first adhering layer and a second adhering layer, wherein the first adhering layer is adhered on the glass substrate and the shielding layer, while the second adhering layer is provided on the first adhering layer. The touch sensing circuit substrate, on which the second adhering layer is adhered, has a peripheral portion, on which at least a bonding pad is provided, and a central portion, which is surrounded by the peripheral portion. An area of the first adhering layer facing the glass substrate is no smaller than that of the visible portion, while an area of an opposite surface of the first adhering layer is no larger than that of the central portion of the touch sensing circuit substrate.

The present invention further provides a touch sensing module, which includes a glass substrate, a shielding layer, an adhering member, and a touch sensing circuit substrate. The shielding layer is provided on a surface of the glass substrate, wherein the shielding layer partially shields the glass substrate. The adhering member has a first adhering layer and second adhering layer which are adhered to each other, wherein the first adhering layer is adhered on the glass substrate and the shielding layer. The second adhering layer is adhered on the touch sensing circuit substrate. A hardness of the first adhering layer is less than that of the second adhering layer.

Whereby, the touch sensing module provided in the present invention effectively prevents air bubbles from forming, and the touch sensing circuit substrate would not be deformed or damaged by excessive force.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of a preferred embodiment of the present invention;

FIG. 2 is a schematic diagram of the touch sensing circuit substrate of the preferred embodiment of the present invention;

FIG. 3 and FIG. 4 are schematic diagrams showing each step in the manufacturing process of the preferred embodiment of the present invention; and

FIG. 5 and FIG. 6 are schematic diagrams showing other steps in the manufacturing process of the preferred embodiment of the present invention.

### DETAILED DESCRIPTION OF THE INVENTION

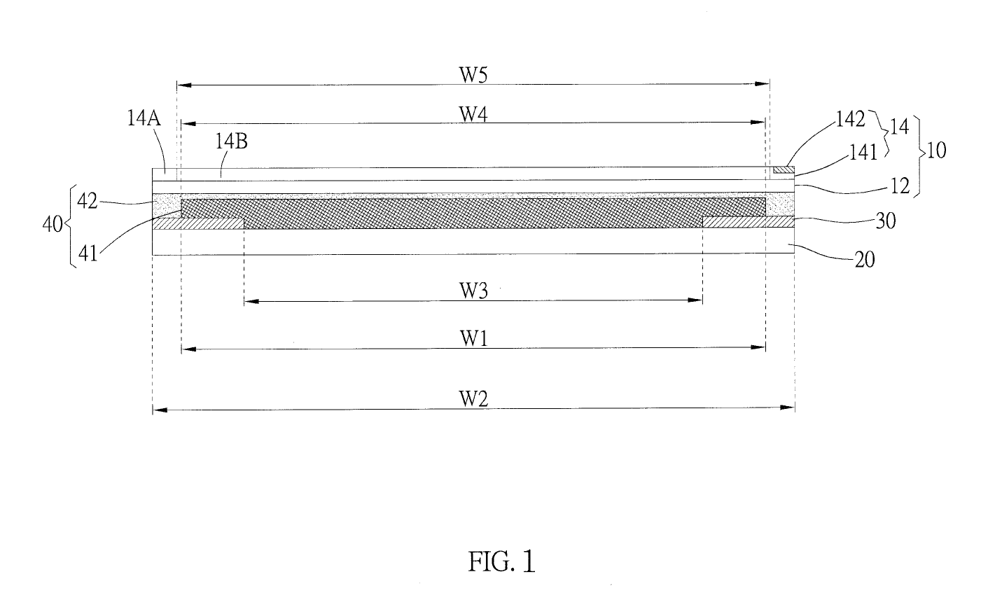

As shown in FIG. 1 to FIG. 3, a touch sensing module of the preferred embodiment of the present invention includes a touch sensing circuit substrate 10, a glass substrate 20, a shielding layer 30, and an adhering member 40.

The touch sensing circuit substrate 10 includes a flexible substrate 12 and a touch detection circuit 14, wherein the flexible substrate 12 is made of a flexible material, such as polymide (PI) and polyethylene terephthalate (PET), and a thickness thereof is thinner than 10 μm, which is merely an example, and not a limitation of the present invention. The touch detection circuit 14 includes a detection electrode layer 141 and a plurality of bonding pads 142, wherein the detection electrode layer 141 has a plurality of touch electrodes to generate electric signals in response of touches detected on the detection electrode layer 141, and the bonding pads 142 are electrically connected to the touch electrodes respectively, wherein the electric signals are transmitted to a signal bus (e.g., a flexible printed circuit board, which is not shown) via the bonding pads 142. The detection electrode layer 141 is, by definition, separated into a peripheral portion 14A and a central portion 14B. In more details, the peripheral portion 14A is defined along a periphery of the detection electrode layer 141 to surround the central portion 14B, and the bonding pads 142 are located in the peripheral portion 141A only. In other words, the bonding pads 142 are provided at somewhere along the periphery of the detection electrode layer 141, and therefore the bonding pads 142 can be easily connected to the signal bus.

The glass substrate 20 is provided for the touch sensing circuit substrate 10 to be affixed on, wherein the shielding layer 30 is provided on a surface of the glass substrate 20. The shielding layer 30 shields the peripheral portion 141A and a periphery of the central portion 141B to make the related circuit structure invisible; in other words, the shielding layer 30 leaves a preferably rectangular hole at a center thereof. In the preferred embodiment, the glass substrate 20 is a cover lens, while in other embodiments, the glass substrate 20 can be color filters or polarizing filters. In the preferred embodiment, the shielding layer 30 is provided along a periphery of a surface of the glass substrate 20, wherein a portion of the surface of the glass substrate 20 which corresponds to the hole of the shielding layer 30 is defined as a visible portion. The shielding layer 30 is formed by stacking more than one sub-layer. In the preferred embodiment, the shielding layer is formed with multiple sub-layers of ink in order to achieve a better shielding performance.

The adhering member 40 includes a first adhering layer 41 and a second adhering layer 42 which are adhered to each other. The first adhering layer 41 is adhered on the glass substrate 20 through the hole of the shielding layer 30 and a portion of the shielding layer 30, while the second adhering layer 42 is adhered on the touch sensing circuit substrate 10, the first adhering layer 41, and the rest portion of the shielding layer 30. A surface of the first adhering layer 41 opposite to the glass substrate 20 and a surface of the second adhering layer 42 opposite to the touch sensing circuit substrate 10 are mutually adhered, while a part of the second adhering layer 42 is adhered on the shielding layer 30 to fix the touch sensing circuit substrate 10 and the glass substrate 20.

To avoid air bubbles from occurring, and to prevent the detection electrode layer 141 or the bonding pads 142 from being deformed or damaged due to excessive force, the adhering member 40 in the preferred embodiment satisfies the following conditions:

(1) a hardness of the first adhering layer 41 is less than that of the second adhering layer 42;

(2) an area W1 of a surface of the first adhering layer 41 facing the glass substrate 20 is smaller than an area W2 of a surface of the second adhering layer 42 facing the touch sensing circuit substrate 10, and no smaller than (preferably, larger than) an area W3 of the visible portion;

(3) an area W4 of a the surface of the first adhering layer 41 facing the touch sensing circuit substrate 10 is no larger than (preferably, smaller than) an area W5 of the central portion 14B; and

(4) an average thickness of the first adhering layer 41 is thicker than that of the second adhering layer 42 and that of the shielding layer 43 at the same time. In practice, the average thickness of the first adhering layer 41 can be thicker than 150 μm, and the average thickness of the second adhering layer 42 can be thinner than 100 μm. However, these numbers are not a limitation of the present invention.

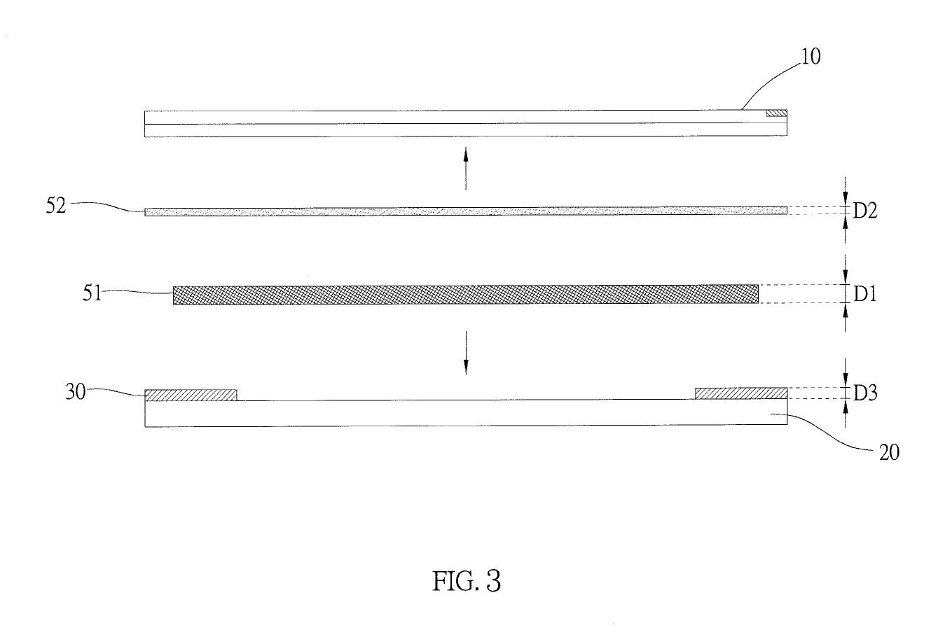

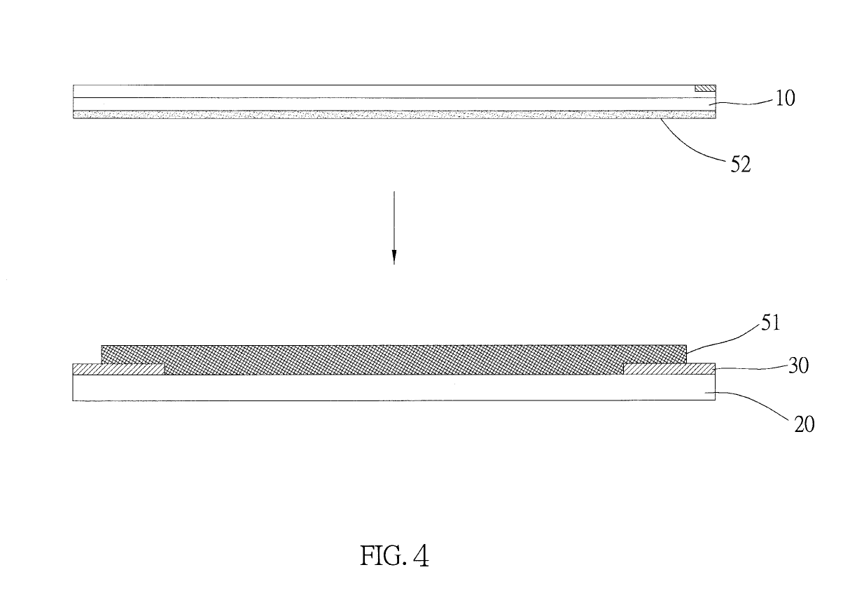

As shown FIG. 3 and FIG. 4, a manufacturing process of the touch sensing module includes the step of preparing the touch sensing circuit substrate 10, the glass substrate 20, a first glue 51, and a second glue 52, wherein the glass substrate 20 has been provided with the shielding layer 30 thereon; the first glue 51 and the second glue 52 are made of light-curable epoxy, which is gum or fluid before being cured; a hardness of the first glue 51 is less than that of the second glue. In practice, the first glue 51 and the second glue 52, of course, can be made of other glutinous materials which are heat-curable or have different curing properties.

After that, as shown in FIG. 3, the first glue 51 is then coated on the glass substrate 20 and the shielding layer 30, and the second glue 52 is coated on the touch sensing circuit substrate 10 as well. The first glue 51 and the second glue 52 are then glued together, wherein the second glue 52 partially covers the shielding layer 30 in response to the exerted force. The first glue 51 can be coated on the glass substrate 20 and the shielding layer 30 without covering a portion of the shielding layer 30 which corresponds to the peripheral portion 14A, and also leave a predetermined space uncovered to make portions of the glass substrate 20 and the shielding layer 30 which are covered by the first glue 51 larger than the visible portion, and smaller than a portion of the touch sensing circuit substrate 10 covered by the second glue 52 at the same time.

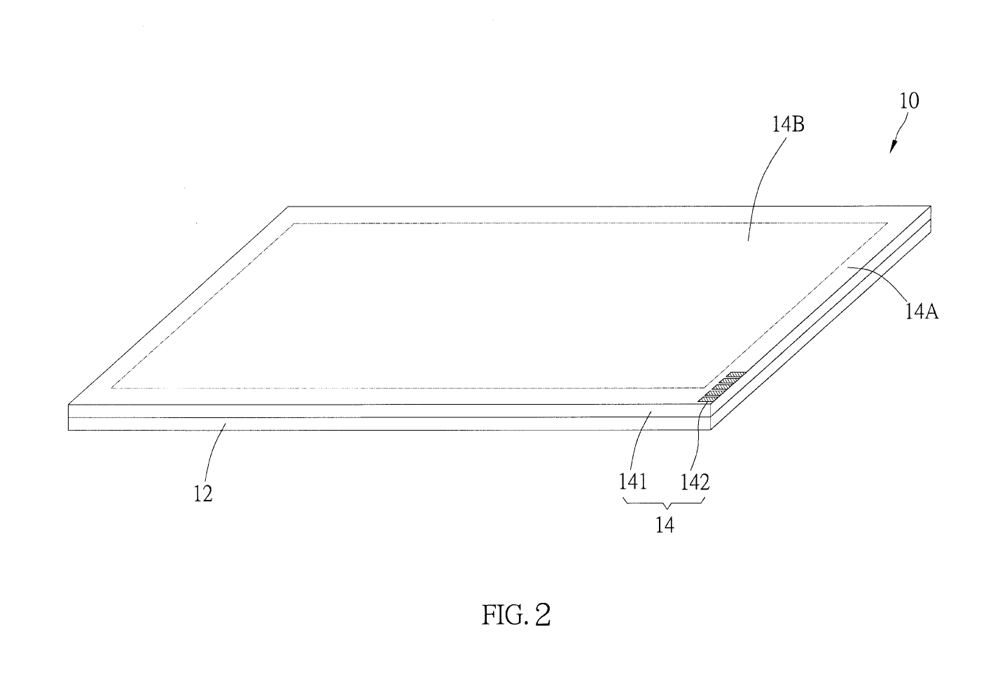

In addition, as shown in FIG. 2, an average thickness D1 of the first glue 51 in the preferred embodiment is thicker than an average thickness D2 of the second glue 52, wherein the thickness difference between D1 and D2 is preferably thicker than 0.25 μm. The average thickness D1 of the first glue 51 is also thicker than an average thickness D3 of the shielding layer 30. The reason why the first glue 51 is required to be thicker and softer is because that while the first glue 51 is being coated on the glass substrate 20 and the shielding layer 30, it tends to be flattened and smoothly attached to the glass substrate 20 and the shielding layer 30, which prevents air bubbles from forming. In addition, the thicker first glue 51 and the second glue 52 are prevented from pressing the bonding pads 142 of the touch sensing circuit substrate 10 with the aforementioned comparison relations among the area sizes (the portions of the glass substrate 20 and the shielding layer 30 covered by the first glue 51 is smaller than the portion of the touch sensing circuit substrate 10 covered by the second glue 52, and also larger than the visible portion), and therefore the pad 142 would not be damaged.

After the first glue 51 and the second glue 52 are glued together, they are exposed to light to be cured, wherein the first glue 51 becomes the first adhering layer 41 after being cured, and the second glue 52 becomes the second adhering layer 42 after being cured. As a result, the adhering member 40 is formed to fix the touch sensing circuit substrate 10 and the glass substrate 20, and the touch sensing module shown in FIG. 1 is then completed. The aforementioned limitations relating to the material, the coated area, and the average thickness of the first glue 51 are determined to make the first adhering layer 41 and the second adhering layer 42 satisfy the aforementioned conditions (1) to (4).

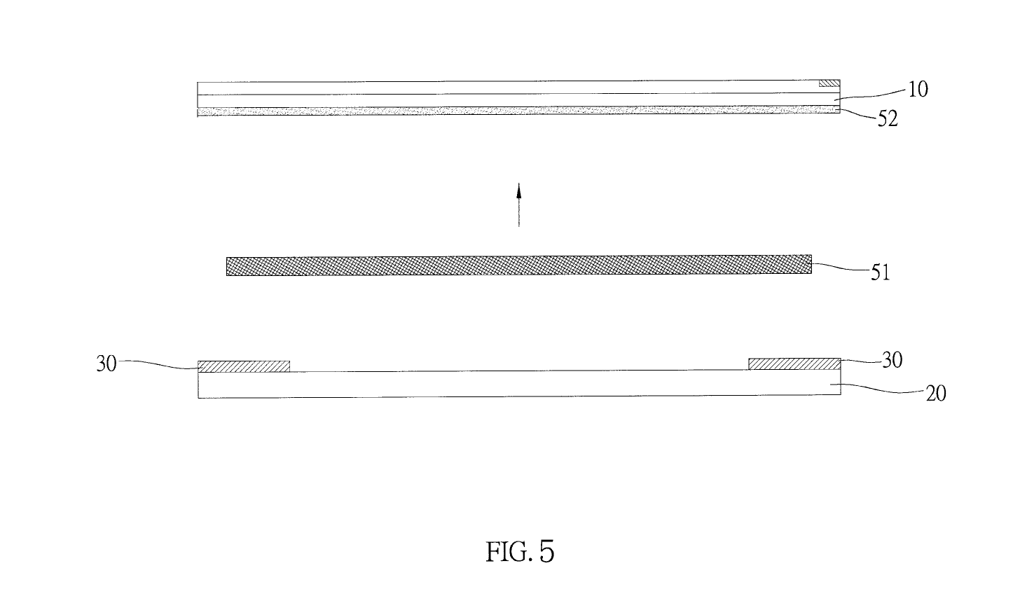

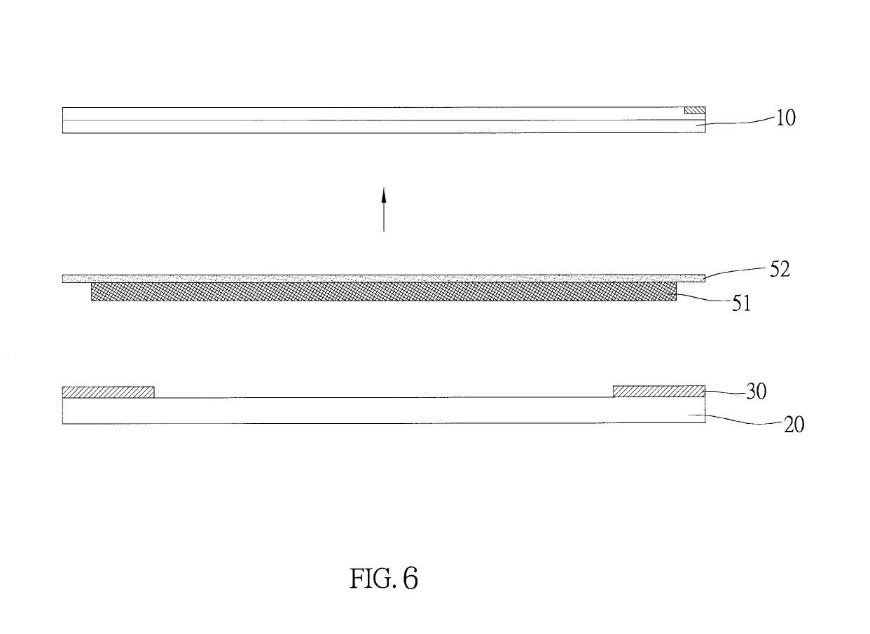

It is worth mentioning that the order of coating the first glue 51 and the second glue 52 on the glass substrate 20, the shielding layer 30 and the touch sensing circuit substrate 10 is subject to change according to different material properties or requirements. For example, as shown in FIG. 4, the second glue 52 can be coated on the touch sensing circuit substrate 10 first to glue the first glue 51 and the second glue 52 together, and after that, the first glue 51 is coated on the glass substrate 20 and the shielding layer 30. In addition, as shown in FIG. 5, the first glue 51 and the second glue 52 can be glued together first, then the second glue 52 is coated on the touch sensing circuit substrate 10, and finally, the first glue 51 is coated on the glass substrate 20 and the shielding layer 30. These alternative processes can prevent air bubbles from forming as well, and the pads would not be deformed or damaged either.

It must be pointed out that the embodiments described above are only some preferred embodiments of the present invention. All equivalent structures which employ the concepts disclosed in this specification and the appended claims should fall within the scope of the present invention.

What is claimed is:

1. A touch sensing module, comprising:
a glass substrate;
a shielding layer provided on a surface of the glass substrate, wherein the shielding layer partially shields the glass substrate, and the glass substrate has a visible portion not shielded by the shielding layer;
an adhering member including a first adhering layer and a second adhering layer, wherein the first adhering layer is adhered on the glass substrate and the shielding layer, while the second adhering layer is provided on the first adhering layer; and
a touch sensing circuit substrate, on which the second adhering layer is adhered, having a peripheral portion, on which at least a bonding pad is provided, and a central portion, which is surrounded by the peripheral portion;
wherein an area of the first adhering layer facing the glass substrate is no smaller than that of the visible portion, while an area of an opposite surface of the first adhering layer is no larger than that of the central portion of the touch sensing circuit substrate.

2. The touch sensing module of claim 1, wherein a hardness of the first adhering layer is less than that of the second adhering layer.

3. The touch sensing module of claim 1, wherein an average thickness of the first adhering layer is thicker than that of the second adhering layer.

4. The touch sensing module of claim 1, wherein an average thickness of the first adhering layer is thicker than that of the shielding layer.

5. The touch sensing module of claim 1, wherein the surface of the first adhering layer opposite to the surface of the glass substrate is adhered to a surface of the second adhering layer opposite to a surface of the touch sensing circuit substrate.

6. The touch sensing module of claim 1, wherein a part of the second adhering layer is adhered to the shielding layer.

7. A touch sensing module, comprising:
a glass substrate;
a shielding layer provided on a surface of the glass substrate, wherein the shielding layer partially shields the glass substrate;
an adhering member having a first adhering layer and second adhering layer which are adhered to each other, wherein the first adhering layer is adhered on the glass substrate and the shielding layer; and
a touch sensing circuit substrate, on which the second adhering layer is adhered;
wherein a hardness of the first adhering layer is less than that of the second adhering layer.

8. The touch sensing module of claim 7, wherein a portion of the glass substrate has a visible portion not shielded by the shielding layer; the visible portion is smaller than a surface of the first adhering layer facing the glass substrate.

9. The touch sensing module of claim 7, wherein an average thickness of the first adhering layer is thicker than that of the second adhering layer.

10. The touch sensing module of claim 7, wherein an average thickness of the first adhering layer is thicker than that of the shielding layer.

11. The touch sensing module of claim 7, wherein the surface of the first adhering layer opposite to the surface of the glass substrate is adhered to a surface of the second adhering layer opposite to a surface of the touch sensing circuit substrate.

12. The touch sensing module of claim 7, wherein a part of the second adhering layer is adhered to the shielding layer.
